(19) United States
(12) Patent Application Publication
(10) Pub. No.: US 2026/0365489 A1
(43) Pub. Date: Nov. 19, 2026

(54) ELEVATOR, METHOD FOR INSTALLING ELEVATOR, BUILDING HAVING ELEVATOR, AND METHOD FOR CONSTRUCTING BUILDING

(71) Applicant: HYUNDAI ELEVATOR CO., LTD, Chungcheongbuk-do (KR)

(72) Inventors: Tae Won Lee, Chungcheongbuk-do (KR); Sung Joon Bae, Chungcheongbuk-do (KR); Woo Sung Hwang, Chungcheongbuk-do (KR); Jae Kwang Yu, Chungcheongbuk-do (KR); Dong Hwan Oh, Chungcheongbuk-do (KR); Chae Hyun Lim, Chungcheongbuk-do (KR)

(21) Appl. No.: 19/434,675

(22) Filed: Dec. 29, 2025

(30) Foreign Application Priority Data
May 15, 2025 (KR) 10-2025-0063137

(51) Int. Cl. B66B 19/00; B66B 9/00; B66B 11/00

(52) U.S. Cl. CPC B66B 19/007; B66B 9/00; B66B 11/0005

(57) ABSTRACT

The method for installing an elevator of the present disclosure can be performed by providing an opening in the ceiling of a building and a cover for blocking the opening, and introducing an elevator module through the opening.

### CROSS-REFERENCE TO RELATED APPLICATIONS

This application is based on and claims priority under 35 U.S.C. § 119 to Korean Patent Application No. 10-2025-0063137 filed on May 15, 2025, with the Korean Intellectual Property Office, the disclosure of which is incorporated by reference herein in its entirety.

### BACKGROUND

The present disclosure relates to an elevator, a method for installing an elevator, a building having an elevator, and a method for constructing a building.

Technological advancements related to elevators are occurring rapidly. Elevators are advancing in step with the trend toward high-speed operation, high efficiency, eco-friendliness, and smarter operation. One example of this technological advancement is the modular elevator. Unlike conventional elevators, the modular elevators are machine-room-less (MRL) elevators, with their drive, control, and safety systems assembled as individual modules within the hoist way. The modular elevators are manufactured in advance by modularizing components at the elevator factory. They can then be easily assembled on-site. This shortens construction period and is effective in safety management and cost reduction. Other examples include preemptive fault detection and smart control technologies utilizing artificial intelligence (Al) and/or the Internet of Things (IoT). Furthermore, attempts are being made to expand the technology into future means of transportation, such as urban air mobility (UAM), which the applicant is researching. Thus, elevators are expanding beyond their mere means of transportation within buildings, and are undergoing various technological expansions.

An example of the technology for the modular elevator is Application No. 10-2024-199353, filed by the applicant herein, entitled “Entrance Module, Modular Elevator Including Entrance Module, and Method for Assembling Entrance Module.” This technology introduces a technology for precision assembly of the platform module. Another technology is Application No. 10-2024-0081110, filed by the applicant herein, entitled “Method for Manufacturing a Modular Elevator.” This technology introduces a technology for precision assembly of the rails.

Despite being installed within a building, the elevators are often treated as a separate process from the building itself. Consequently, numerous inconsistencies arise on-site.

### SUMMARY

The prior art has the following technical problems.

First, when remodeling or replacing an old elevator, the entire elevator must be disassembled. This leads to long-term disruption and significant costs. Specifically, in the conventional elevators, the elevator components are provided as a single-piece structure with the upper and lower parts fixed together. Therefore, disassembly of elevator components requires sequential disassembly, starting from the inside in the reverse direction. Ultimately, this process requires several weeks or more to disassemble and reinstall the elevator. Furthermore, elevator operation is completely suspended during this period, causing significant inconvenience to elevator users.

Second, when remodeling or replacing old elevators, the manual approach to introducing elevator components can lead to low construction efficiency. Specifically, traditional elevator designs rely on horizontal entry and/or internal lifting of components into the hoist way. This approach increases equipment inefficiency and operational risks. This problem is exacerbated in high-rise buildings.

Hereinafter, a solution to the technical problem will be described. The first problem of the [technical problem] can be solved by providing an opening at an upper portion of the hoist way and/or enabling vertical introduction and/or withdrawal of elevator components through the opening using an external crane. Accordingly, rapid and stable replacement of elevators can be possible even in high-rise buildings. The second problem of the [technical problem] can be solved by removing and reinstalling each elevator module, and/or providing an opening at the upper portion of the hoist way, and/or enabling vertical introduction and/or withdrawal of elevator components through the opening using an external crane. The opening of the hoist way can be provided by changing the ceiling to a detachable structure when replacing the elevator, or by providing a detachable ceiling for the opening during building construction.

The method for installing an elevator of the present disclosure can be performed by providing an opening in the ceiling of a building and a cover for blocking the opening, and introducing an elevator module through the opening.

According to the present disclosure, a method for installing an elevator may include providing an opening, at an upper end of a hoist way, aligned with the hoist way in a vertical direction, and disconnecting first elevator components constituting the elevator to be removed; sequentially withdrawing the first elevator components through the opening, starting from an upper component located in an upper portion of the elevator to be removed and ending with a lower component located in a lower portion of the elevator to be removed; preparing second elevator components constituting an elevator to be installed; sequentially introducing the second elevator components through the opening, starting from a lower component located in a lower portion of the elevator to be installed and ending with an upper component located in an upper portion of the elevator to be installed; and fastening the second elevator components.

The second elevator components may include an elevator module of the elevator to be installed.

The elevator module may be provided as a hexahedral frame to which a plurality of bars of predetermined cross-sections extending in the vertical direction, in a front and rear direction, and in a left and right direction are connected.

A rail may be assembled to the frame.

Among the elevator modules, a lower end module located at a lower end of the elevator to be installed may be provided so as to be detachable from a building.

The elevator module may include at least two elevator modules, and the elevator modules may be fastened to each other.

The opening may be provided in one of the following ways: providing the opening in the wall of the building providing the hoist way when the elevator to be removed is removed, and providing the opening in the wall of the building when the building having the elevator to be removed is constructed.

The opening may be closed by a cover after the second elevator components are introduced.

At least one of the cover, the first elevator components, and the second elevator components may be introduced or withdrawn by a crane.

The method for installing an elevator may further include another opening provided by opening the side of the hoist way at the lower portion of the hoist way, through the opening, at least one of the first elevator components and the second elevator components may be introduced or withdrawn.

According to the present disclosure, in a method of constructing a building, in order to perform the method of claim 1, the opening may be provided during construction of the building, and the opening may be closed with a cover capable of blocking the opening.

According to the present disclosure, an elevator may include a hoist way which is a passage through which a car raises and lowers in a building; a cover capable of opening or closing an opening provided at an upper end of the hoist way and aligned with the hoist way in a vertical direction; a platform provided at each floor where the car stops; a traction machine provided at an upper portion of the hoist way for raising and lowering the car; a counterweight connected to the opposite side of the car by a rope and moving in the opposite direction of the car; a door module provided at the platform for opening and closing in conjunction with a door of the car; and a rail for guiding the movement of at least one of the car and the counterweight in the vertical direction.

The cover may be provided on the ceiling of the building.

The elevator may further include a step provided on an upper wall of the building for disposing the cover.

The step may be a groove recessed downward from the wall toward the hoist way or a protrusion extending upward from the wall.

The elevator may further include a hole provided in the cover, a bolt provided in the step and passing through the hole when the cover is seated; and a nut fastened to the bolt.

A lifting protrusion may be provided on the cover to lift the cover.

The lifting protrusions may be provided at the four corners of the cover of a quadrilateral shape.

The elevator may further include an elevator module provided as a hexahedral frame in which at least one of the traction machine, the door module, and the rail is assembled.

According to the present disclosure, when a modular elevator is utilized to replace an old elevator, the replacement work can be performed more quickly and safely.

According to the present disclosure, when remodeling a modular elevator, it can be effective in terms of speed and safety of replacement work.

According to the present disclosure, both construction efficiency and maintainability can be achieved in elevator installation and building construction. In particular, modular elevators can be stacked individually, significantly enhancing efficiency. Since the elevator modules can be installed and removed individually from their respective frames, rapid demolition and new installation are possible during elevator remodeling and replacement due to aging.

According to the present disclosure, by applying a pre-assembled modular structure at the elevator production site, construction work can be minimized. Consequently, the quality of the elevator installation and the stability of the installation work can be improved.

### BRIEF DESCRIPTION OF THE DRAWINGS

FIG. 1(a) and 1(b) are structural diagrams illustrating a building and an elevator, where FIG. 1(a) illustrates an elevator provided in a building, and FIG. 1(b) illustrates an elevator in which elevator modules are stacked.

FIG. 2 is a drawing illustrating an elevator and a building according to example 1.

FIG. 3 illustrates a portion of the ceiling of a building according to example 2.

FIG. 4(a)-4(d) are drawings illustrating the installation of an elevator according to example 3 in a time series manner, where FIGS. 4(a) to 4(d) are drawings illustrating the installation of the elevator in a time series manner.

FIG. 5 is a drawing illustrating an elevator and a building according to example 4.

FIG. 6 is a flowchart explaining a method of installing an elevator according to example 1 the present disclosure.

FIG. 7 is a flowchart explaining a method of installing an elevator according to example 2 the present disclosure.

FIG. 8 is a flowchart explaining a method of installing an elevator according to example 3 the present disclosure.

### DETAILED DESCRIPTION OF THE EMBODIMENTS

Hereinafter, specific embodiments of the present disclosure will be described in detail with reference to the drawings. The idea of the present disclosure is not limited to the following embodiments. Those skilled in the art who understand the idea of the present disclosure can easily propose other embodiments within the same idea by adding, modifying, deleting, or adding elements. However, this also falls within the idea scope of the present disclosure.

The present disclosure may include a plurality of embodiments. A first element of a first embodiment among the plurality of embodiments may be included by adding or modifying elements of another embodiment. A first element of a first embodiment among the plurality of embodiments and a second element of a second embodiment among the plurality of embodiments may be combined to provide another embodiment not specified in the plurality of embodiments.

In the description of the drawings, regardless of the drawing number and symbol, identical or similar elements are given identical or similar reference numbers, and redundant descriptions thereof may be omitted.

The drawings are provided solely to facilitate understanding of embodiments of the present disclosure, and the technical ideas of the present disclosure are not limited by the attached drawings. It should be understood that all modifications, equivalents, or alternatives included within the idea and technical scope of the present disclosure are included.

In describing the embodiments of the present disclosure, a detailed description of a related known technology may be omitted if it is determined that the detailed description may obscure the gist of the embodiments disclosed in the present specification.

In describing embodiments of the present disclosure, specific examples of related known technologies may be included in the specification. In this case, the technical connection between the known technologies and the present disclosure may be included within the technical idea of the present disclosure.

In the present disclosure, terms including ordinal numbers, such as “first,” “second,” or the like, may be used to describe various elements, but the elements are not limited by the terms. The terms may be used to distinguish one element from other element

When an element is referred to as being “connected” or “accessed” to another element, it should be understood that it may be directly connected or accessed to other element, but that there may be other elements in between. Conversely, when an element is referred to as being “directly connected” or “directly accessed” to another element, it should be understood that there are no other elements in between.

A singular expression may include a plural expression unless the context clearly indicates otherwise.

In the present disclosure, terms such as “comprises” or “has” are intended to indicate the presence of a feature, number, step, operation, element, component, or combination thereof described in the specification. Therefore, they do not exclude the possibility of the presence or addition of one or more other features, numbers, steps, operations, elements, components, or combinations thereof.

In the present disclosure, if the direction is indicated, a direction of gravity can be defined as a vertical direction. A direction perpendicular to the direction of gravity can be defined as a left and right direction. A direction perpendicular to both the vertical and left and right directions can be defined as the front and rear direction. The front and rear direction can be exemplified by the direction viewed by an observer.

### Example 1

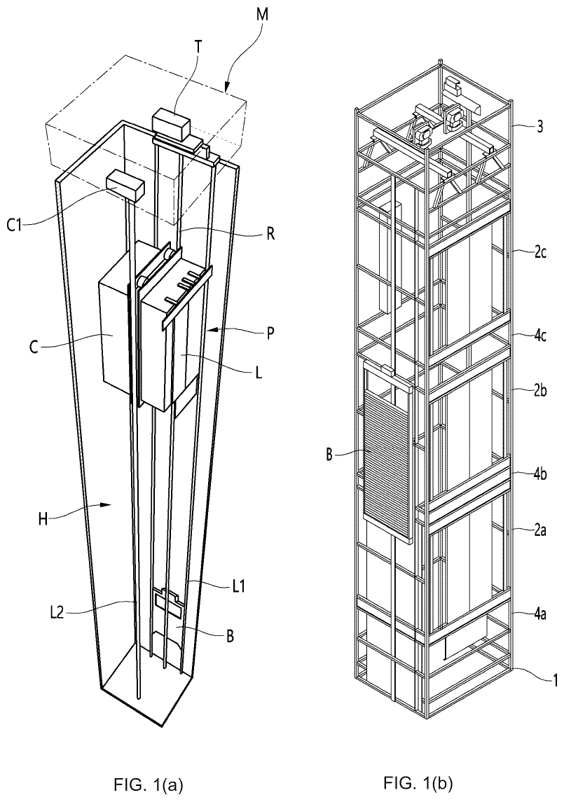

FIGS. 1(a) and 1(b) are structural diagrams illustrating a building and an elevator, where FIG. 1(a) illustrates an elevator provided in a building, and FIG. 1(b) illustrates an elevator in which elevator modules are stacked. See FIGS. 1(a) and 1(b).

### [Configuration and Operation of Elevator]

An elevator can be installed in a building. Here, the building can be exemplified by a reinforced concrete structure, a steel structure, and a modular structure. The building can provide a platform and a hoist way to install the elevator. The building can accommodate the elevator. The platform and the hoist way can form an elevator component. The platform P can be exemplified by an entrance/exit space of each floor where the car C stops. A plurality of platforms can be provided in the building. The hoist way H can be exemplified by a passage through which the car C is raised and lowered. Components such as a traction machine T and a control module C1 that raise and lower the car C can be disposed on the upper end of the hoist way.

A door module L may be provided on the platform. The door module can be opened and closed in conjunction with the door of the car C. The traction machine T can rotate the rope R in both directions. The rope R can be wound around a sheave provided on the output side of the traction machine T. The rope R can extend in both directions with the traction machine as the geometric center. In other words, the rope R is supported by the sheave, and both ends thereof can extend downward by gravity.

The car C may be supported on the first side where the rope extends in one direction. A counterweight B (balance weight) may be supported on the second side where the rope extends in the other direction. The counterweight may compensate for the weight of the car C and the load loaded on the car. The counterweight may reduce energy consumption of the elevator, smoothen the operation of the elevator, and increase the stability of the system. Various methods for connecting the rope R, the car C, and the counterweight B may be provided according to the specifications, use, allowable load, and standards of the building and the elevator. Various methods for connecting the rope R, the car C, and the counterweight B may be included in the idea of the present disclosure.

According to the control of the control module C1, the traction machine T can be selectively driven. By moving the rope R wound around the sheave, the car C can move in the hoist way H in the vertical direction. By moving the rope R wound around the sheave, the car C and the counterweight B can move in the vertical direction. At this time, the car C and the counterweight B can move in opposite directions to each other. The vertical movement of the car C and the counterweight B can be guided by the first rail L1 and the second rail L2.

According to the control of the control module C1, the car C can stop at a specific location. The car C can stop corresponding to a specific platform P. The door of the car C and the door module L of the specific platform can be opened together.

Additional portions may be required for the configuration and operation of the elevator. For example, the counterweight B may also be provided with a sheave around which the rope R is wound. Even if each portion is not described in the present disclosure, the applicant declares that the portions necessary for the configuration and operation of the elevator are included in the present disclosure.

### [Configuration and Operation of Rails L1 and L2]

The rails L1 and L2 can be installed to extend vertically from the inner surface of the hoist way H. The rails L and L2 can be fastened to the inner surface of the hoist way H. The rails L and L2 can be directly fastened to the inner surface of the hoist way H using a single type of fastener or indirectly fastened using two or more types of fasteners. The rails L and L2 can guide the vertical movement of the car C and the counterweight B. The rails can prevent the car C and the counterweight B from swinging in the left and right direction and in the front and rear direction. The rails can have a plurality of sub-components connected vertically. The sub-components can refer to sub-components that form a component of the elevator. For example, a rail part of a predetermined length that provides a component as a single rail that is a component of the elevator can be referred to as a sub-component with respect to the single rail. The same applies hereinafter.

If the alignment of the sub-components is misaligned, problems such as vibration may occur during elevator operation. Furthermore, once the rail is fixed, it is difficult to adjust the alignment of the rail even if an error in the alignment of the rail is confirmed due to the amplified joint tolerance between a plurality of sub-components. As a technology to resolve this, the applicant's prior art application No. 10-2024-0081110, entitled “Method for Manufacturing a Modular Elevator,” discloses a fish plate, a clip member, and a fixing block for aligning. Precisely fixing the rail to the reference position can be said to be one of the core technologies in the field of elevator technology.

### [Elevator Module]

The elevator modules can be classified according to the height at which the modules are stacked in the hoist way. For example, the modules can include a lower end module 1 at the lowest floor. An intermediate module 2 can be stacked on top of the lower end module corresponding to each platform. The door module L can be installed corresponding to the intermediate module. At least two 2a, 2b, and 2c of the intermediate modules can be provided. An adapter module 4 that directly contacts the intermediate module can be provided on at least one of the upper end and the lower end of one of the intermediate modules. The adapter module 4 can be provided to adjust the vertical spacing between each module according to the specifications of the building. At least two 4a, 4b, and 4 c of the adapter modules 4 can be provided as needed. An upper end module 3 can be stacked on the upper side of the highest intermediate module among the at least two intermediate modules.

The module may be provided by fastening bars having predetermined cross-sections extending in the vertical direction, in the front and rear direction, and in the left and right direction. The module may be provided as a hexahedral frame in which a plurality of the bars are connected. The cross-section of the bar may have at least one bent part. The cross-section of the bar may be provided as a square. The cross-section of the bar may be provided as a hollow square. The cross-section of the bar may be provided as a hollow square with one edge removed. The cross-section of the bar may be provided as a hollow square with two consecutive edges removed. The bars or the module may be fastened to the building or another adjacent module. The elevator components may be fixed and assembled to the frame. For example, rails, doors, buffers, or the like may be pre-assembled to the frame at the elevator production site.

Any one of the intermediate modules may be provided corresponding to any one of the platforms. In other words, one door module L may correspond to one intermediate module that is stacked. Of course, according to the specifications of the modules, one or more door modules may correspond to one intermediate module, or one or more intermediate modules may correspond to one door module. This may correspond to various specifications of the building. A pit module may be provided in the lower end module 1. The pit module may be disposed at the lowest end portion of the elevator, and a buffer and a sensor may be installed therein. The pit module may be directly disposed on the foundation structure during the construction of the building. A machine room module may be provided in the upper end module 3. The machine room module may provide a space for supporting a driving device. If the space is provided separately, it may be called a machine room M. In the present example, a separate machine room may not be provided. The traction machine T, the winch T1, electrical wiring, and control equipment may be supported therein. The upper end module 3 may be provided in two layers. A winch and a work plate may be provided on the lower layer of the two layers.

As an elevator module, a shaft module may be provided. The shaft module may provide a guide for a car to safely raise and lower by contacting the shaft module. The shaft module may include the rail and electrical wiring. At least one of the shaft module and the door module may be pre-fastened to the intermediate module. Here, the meaning of “pre-fastened” may mean that the module is fastened to the frame providing the module and moves together during movement.

As an elevator module, the control module C1 may be provided. In a narrow sense, the control module may refer to a control panel disposed in the machine room. In a broad sense, the control module C1 may include components such as a control panel, a communication device, an emergency backup power source, a remote monitoring system, a power line, a control line, and a safety circuit. The control module may also be disposed in other areas of the building other than the hoist way and the platform.

### [Elevator Remodeling or Replacement]

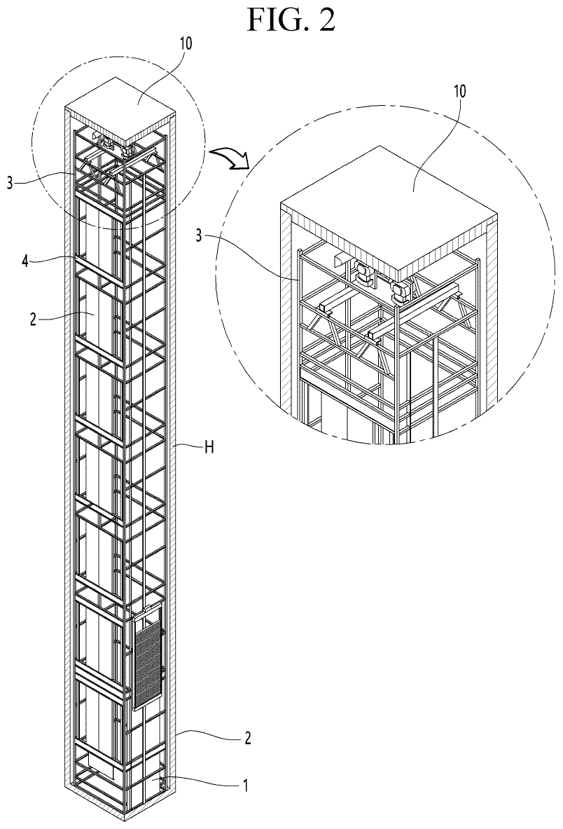

The present disclosure has a technical feature that facilitates the remodeling or replacement of an elevator. FIG. 2 is a drawing illustrating an elevator and a building according to the present disclosure. See FIG. 2.

A cover 10 may be provided in a building at a location connected to a hoist way. The cover 10 may block an opening of the hoist way H. The opening may have a rectangular shape (same cross-section as the hoist way). The cover may selectively open or close the opening. The opening may be provided at an upper end of the hoist way. The upper end of the hoist way may refer to an upper wall of the hoist way. The upper end of the hoist way may be connected to the ceiling of the building. The opening of the hoist way may be provided by at least one of: changing the ceiling of the building (including the upper wall of the hoist way) to a detachable structure when replacing an elevator; and providing a detachable ceiling (including the upper wall of the hoist way) for the opening when constructing a building. The material of the cover may be a material having a predetermined strength. For example, stainless steel or concrete of a predetermined thickness may be used.

This disclosure describes the provision of the opening during building construction. The building construction process may include foundation construction for tamping the ground, framework for erecting the building frame, and finishing construction for finishing the interior and exterior of the frame. In the present disclosure, an opening may be provided at the upper end of an hoist way during the framework construction. The opening may be covered by a cover 10. The cover 10 may be removed when necessary. When the cover is removed, the hoist way may be exposed to the outside. The elevator module may be introduced and withdrawn through the opening. In this case, the introduction and withdrawal may be performed for each elevator module.

When replacing an elevator, openings in a building can be provided through additional construction on the building's ceiling (rooftop). For example, if the building is reinforced concrete, the area connecting to the upper end of the hoist way can be provided through cutting, reinforcing, and covering construction. For example, if the building is steel structure, the wall connecting to the upper end of the hoist way can be separated and removed. For example, for modular buildings, the same process can be used for steel structures.

Replacing the elevator may include removing an elevator component through the opening and installing an elevator component through the opening. The elevator component may include an elevator module.

The process of removing an elevator module from the hoist way can sequentially remove the frame (hexahedral frame) of each elevator module from the upper portion. For example, the removal of the elevator modules can be provided in the order of the upper end module 3, the intermediate module 2 (including a plurality of modules), and the lower end module 1. If necessary, an adapter module 4 can be applied. Each module can be separated before removal. The separation of each module can be performed by releasing the connecting member between the modules. Even in a non-modular elevator, the elevator component can be withdrawn through the opening.

In the hoist way, the frames of the elevator modules may be sequentially stacked from the lower portion. In other words, each module of the elevator may be sequentially stacked from the lower portion. For example, the installation (stacking) of the elevator modules may be provided in the order of the lower end module, the intermediate module (including a plurality of modules), and the upper end module. In order to ensure alignment and fixation between the frames during the stacking process between the frames, the frames may be provided with an interconnection structure or fixing part between the frames. As another example, the frames may be fastened to the surface of the hoist way. One frame may be fastened to at least one of the inner surface of the hoist way and another adjacent frame.

To facilitate the removal of the elevator, the lower end module may not be integrated into the building. For example, if the building is made of reinforced concrete, the lower end module may not be embedded in the reinforced concrete. In other words, during the curing process of the concrete, a portion of the lower end module may be embedded within the concrete and not be permanently fixed. Accordingly, the lower end module may be introduced and/or withdrawn through the opening 31. At this time, a crane may be used for the introduction and/or withdrawal. The lower end module may be fastened to the building using a member such as a bolt. It should be noted that the bolt is capable of being released. Consequently, the lower end module is detachable from the building.

When remodeling the elevator, the elevator components can be introduced and withdrawn through the opening.

### Example 2

Example 2 describes specific examples of the cover and a peripheral portion. The description of example 1 can be applied to example 2. Portions that differ from example 1 are described.

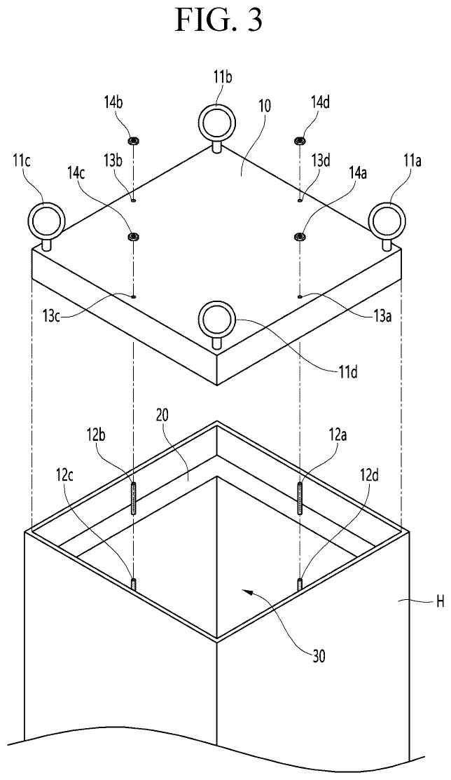

FIG. 3 illustrates a portion of the ceiling of a building according to example 2. See FIG. 3.

An opening 30 may be provided at a location aligned with the hoist way in the vertical direction. The opening 30 may have the same or larger size in the front and rear and left and right directions of the hoist way. Accordingly, the introduction and withdrawal of elevator components may not be hindered. A step 20 may be provided at the upper end portion of the opening. The step may be provided on a wall of the building. Here, the wall may be an upper wall of the hoist way. The cover 10 may be seated on the step. The step may guide the seating of the cover. When the cover is disposed on the step, the step and the cover may be sealed with each other. Accordingly, external substances may not be entered into the hoist way. For sealing, a rubber material member may be interposed between the two members.

The step was described as a groove facing downwards within the opening. However, in addition to this, the step may also face upwards. For example, a step may be provided as a protrusion extending upwards from the four corners of the opening. In this case, liquids such as water can be prevented from entering the hoist way.

In order to seal the cover and the step and/or secure the cover, a predetermined fastening structure may be provided. The fastening structure may include a bolt 12 provided in the step, a hole 13 provided in the cover, and a nut 14 fastened to the bolt passing through the hole. The bolt 12 may be an anchor bolt, some of which is embedded in the building and some of which is exposed. The bolt, nut, and hole may be provided at all four corners. These are indicated by a, b, c, and d. When the bolt and nut are fastened, the cover is secured to the building, and when the bolt and nut are loosened, the cover can be detached from the building.

The outer surface of the cover 10 may be provided with a lifting protrusion 11 used when handling the cover. The lifting protrusion 11 may be any one of a bolt, an anchor bolt, and a lifting eyebolt. Some of the lifting protrusions may be embedded and fixed inside the cover, and others may be withdrawn to the outside. Four 11a, 11b, 11c, and 11d lifting protrusions may be provided at the top of the cover. A chain may be hung on the lifting protrusions. The chain may be connected to a crane. By means of a plurality of the lifting protrusions, the cover can be maintained in balance when being handled.

### Example 3

Example 3 presents a specific example of a method for installing an elevator. The installation according to the method for installing an elevator may include elevator remodeling and elevator reinstallation. The descriptions of example 1 and 2 may be applied to example 3.

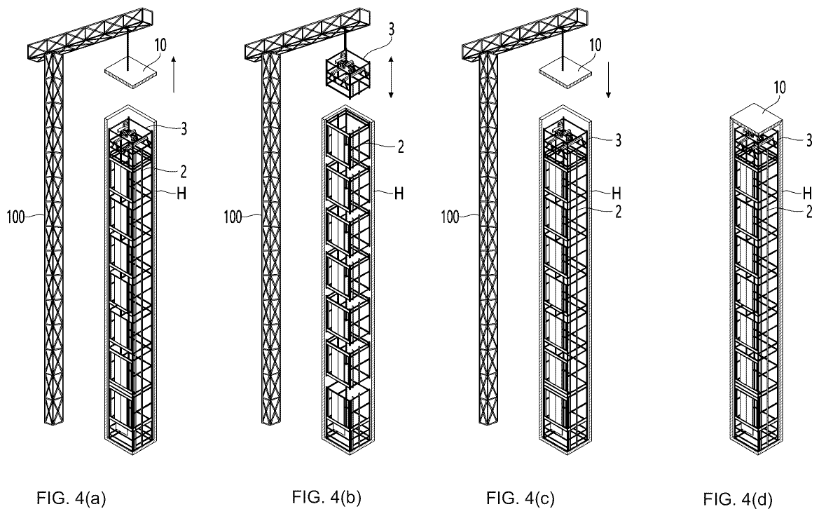

FIGS. 4(a)-4(d) are drawings illustrating the installation of an elevator according to example 3 in a time series manner, where FIGS. 4(a) to 4(d) are drawings illustrating the installation of the elevator in a time series manner. See FIGS. 4(a)-4(d).

A crane 100 may be installed at a construction site. The crane 100 may hoist and raise, and hoist and lower the modules 1, 2, 3, and 4 of the elevator and the cover 10. At this time, the modules of the elevator may be handled (hoisted and raised, and hoisted and lowered) using the hexahedral frame as a unit. The modules of the elevator may be introduced into the hoist way or withdrawn from the hoist way using the hexahedral frame as a unit.

Referring to FIG. 4(a), the crane can hoist and raise the cover 10. The lifting protrusion 11 of the cover can be connected to the crane by a chain. The crane can hoist and lower the cover 10. The hoisted and lowered cover can be disposed at an adjacent location of the building. In the elevator, when the cover is removed, the hoist way H can be exposed to the outside. In another aspect, when the cover is removed from the building, the hoist way can be exposed to the outside.

Referring to FIG. 4(b), the crane can perform the work of hoisting and raising, and hoisting and lowering the elevator components, for example, the elevator modules. In response to one hoisting and raising, and hoisting and lowering by the crane, one elevator module (hexahedral frame) can be withdrawn and introduced. Before being withdrawn, each elevator component can be released from the fastening between the components. First, the elevator components to be withdrawn can be withdrawn from the hoist way, component by component. After all elevator component to be withdrawn have been removed, the elevator components to be introduced can be introduced into the hoist way, component by component. After the elevator components to be introduced have been introduced, the components can be fastened to each other. At this time, if the elevator components are the elevator module, the elevator can be conveniently assembled by connecting the modules.

For each module of the elevator, the withdrawal from the hoist way and the introduction into the hoist way can be applied as already described.

Referring to FIGS. 4 (c), (d), the crane can close the hoist way by hoisting and lifting, and hoisting and lowering the cover 10. The cover can be fastened to the opening. When the cover is fastened, the elevator can be operated while the hoist way is closed.

The aforementioned elevator replacement process can be accomplished quickly and in a short period of time. This can be achieved by at least one of the following: pre-assembling the elevator modules at the elevator production site, handling the elevator modules individually, removing elevator components using a crane, storing the hoisting and raising/hoisting and lowering covers adjacent to the building, and providing an opening at the upper end of the hoist way. Preferably, the desired effects of the present disclosure can be achieved by applying all of the configurations.

### Example 4

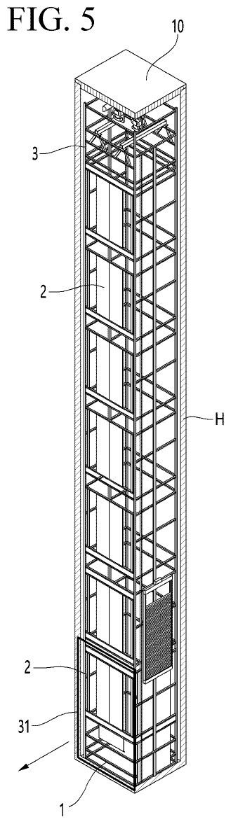

Example 4 illustrates another example of an elevator and a building. The present example applies example 1 through 3, and explains the differences. FIG. 5 is a drawing illustrating an elevator and a building of the present disclosure. See FIG. 5.

The hoist way may be provided with at least two openings. It may include an opening 30 at the upper end of the hoist way (which may be referred to as a first opening) and a second opening 31 provided at the lower end of the hoist way. Here, the bottom may include the lower portion. The function of the first opening may be the same as described above. The second opening 31 may be provided at the lower end of the hoist way. The second opening 31 may be provided by opening a side of the hoist way (a front and rear direction or a left and right direction surface). Accordingly, elevator components may be introduced and withdrawn through the lower end of the hoist way. Here, the elevator components may be a module (a hexahedral frame) of the elevator. At least two second openings may be provided spaced apart from each other in the vertical direction.

When the length of the hoist way is long, i.e., when the building is tall, it may be desirable to provide the second opening. The number of the openings may increase as the building is taller.

According to the at least two openings, the remodeling and replacement of the elevator can be carried out more quickly.

### Example 5

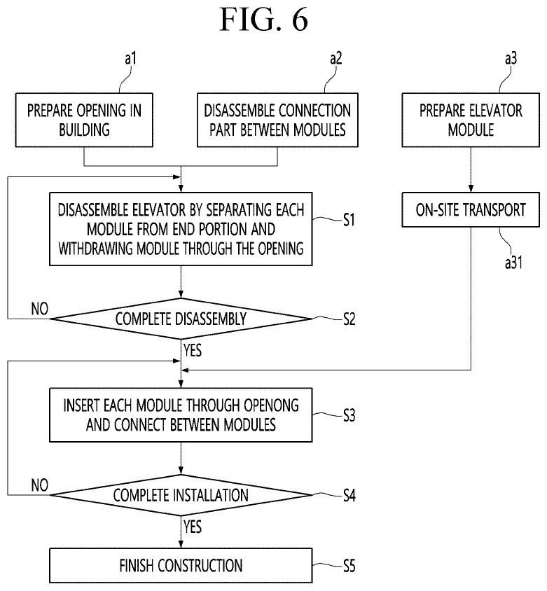

Example 5 specifically describes the method for installing an elevator according to example 1. Example 5 applies the descriptions of examples 1 to 4, and describes other aspects. FIG. 6 is a flowchart illustrating the method for installing an elevator according to example 1 of the present disclosure. See FIG. 6.

An opening 30 may be provided at the upper end of an hoist way in a building (a1). The hoist way may be provided inside the building. To provide the opening, additional construction may be performed on the ceiling of the building.

Regardless of providing the opening (a1), the current elevator component can be disassembled (a2). To prevent injury from falling objects while providing the opening, providing the opening (a1) and disassembling the elevator component can be performed at different times. If the elevator component is the elevator module, this can be performed by disassembling the connection part between the modules.

Once the provision of the opening (a1) and the release of the connection part (a2) are completed, the elevator components can be separated from the rest and withdrawn through the opening (S1). This process (S1) can be repeated until the entire elevator is disassembled. If the elevator components are the elevator modules, the existing elevator can be conveniently disassembled by repeating the same process.

Regardless of the demolition of an existing elevator, the assembly of elevator modules, which are elevator components, can be performed at the elevator manufacturing site (a3). Here, the elevator module may include at least one of a lower end module, an intermediate module, and an upper end module. The lower end module, the intermediate module, and the upper end module may each have a frame (a hexahedron provided as a plurality of bars) that is independently prepared. The frame may have a component including at least one of a rail, a door, a toe guard, and a buffer fastened thereto. The fastening of the component may be provided at the elevator manufacturing site. The frame may be the minimum unit for on-site transport and installation of the elevator. The frame may be provided for each platform. The present disclosure may include the manufacturing of a single module at a single elevator manufacturing site. in other words, the manufacturing may also include manufacturing at different elevator manufacturing sites, as needed.

The prepared elevator modules can be transported to the site immediately when needed (a31). This allows for the timely implementation of the required modules. Consequently, construction sites can be streamlined. Each module at the elevator manufacturing site can be managed with a low inventory level. Consequently, production management of elevator components can be facilitated.

Once the demolition of the existing elevator is completed (S2), the module of the elevator that has been transported (a31) is installed. Here, the installation may include inserting the module of the elevator through the opening and fixing the module of the elevator (S3).

The installation of the elevator modules can be repeated until all modules required for the new elevator are installed. Since the elevator modules are installed individually, the elevator installation process can be performed quickly (S4). Afterwards, the elevator's finishing construction can be performed (S5). The finishing construction may include closing the opening with a cover 10.

The present example can be preferably performed for a building and a method of constructing the building in which the opening and the cover are not separately provided.

### Example 6

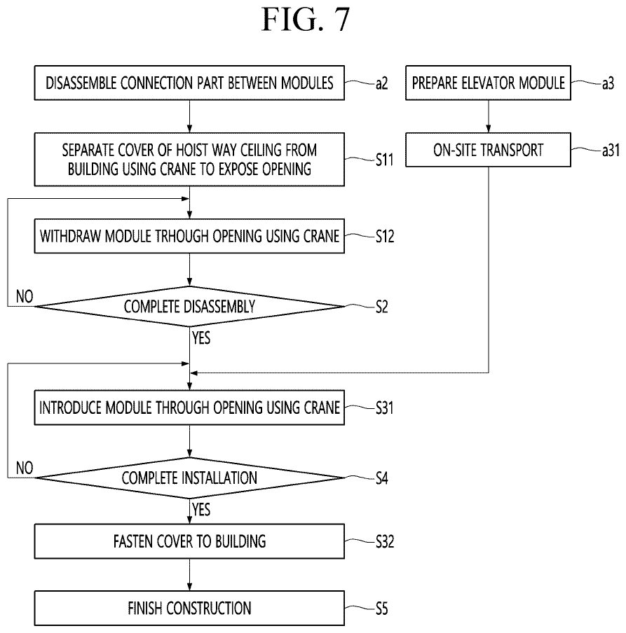

Example 6 is another example that specifically describes the method for installing an elevator according to example 2. The description of example 5 applies, and the differences are explained. FIG. 7 is a flowchart illustrating the method for installing an elevator according to example 2 of the present disclosure. See FIG. 7.

The cover 10 is removed using the crane 100. The cover can be removed while still seated in the building (S11). When the cover is removed, the hoist way can be exposed. The cover may be a component designed in advance during the construction of the building. The cover may also be a newly attached component during an existing additional construction. Thereafter, elevator components can be withdrawn using the crane 100 (S12).

Once the demolition of the existing elevator is complete, elevator components can be introduced and installed through the opening (S31). This step can be repeated until all components are installed (S4). Afterwards, the previously removed cover can be fastened to the building (S32). The cover can be considered a reusable component.

The present method can be preferably applied to a building in which the opening and the cover are already provided and to a method of constructing the building.

### Example 7

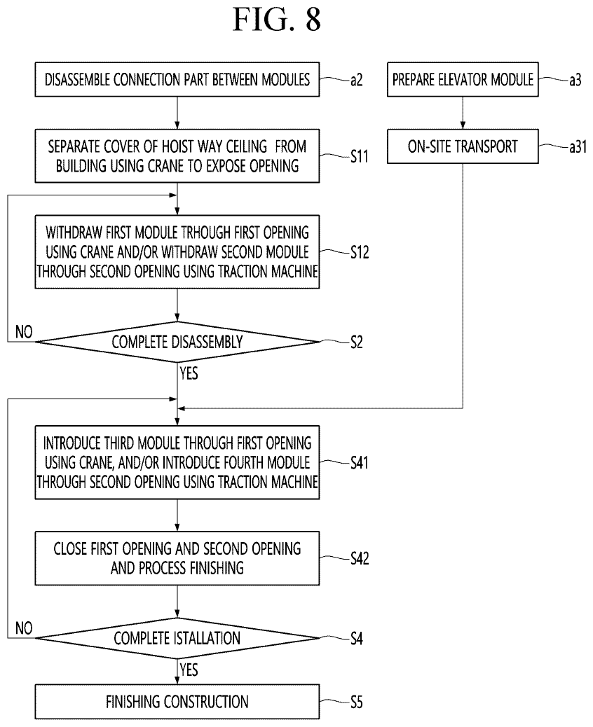

Example 7 is another example that specifically describes the method for installing an elevator according to example 3. The descriptions of example 5 and 6 are applicable, and the differences are described. FIG. 8 is a flowchart illustrating the method for installing an elevator according to example 3 of the present disclosure. See FIG. 8.

A first component (the component is an example of an elevator module, and is hereinafter referred to as a module) may be withdrawn through the first opening 30 using a crane, and/or a second module may be withdrawn through the second opening 31 using a traction machine (S12). The first module may be adjacent to the first opening, and the second module may be adjacent to the second opening. The first module may be disposed higher on the hoist way than the second module. The first and second modules may include modules 1, 2, 3, and 4 of the elevator.

Once the demolition of the existing elevator is complete, the third module can be introduced through the first opening using a crane, and the fourth module can be loaded through the second opening using a loading machine (S41). After all modules have been loaded, the first and second openings can be closed and/or finishing can be performed (S42).

This method has the advantage of enabling faster remodeling and replacement of elevators. This method is advantageously applicable to buildings requiring rapid replacement and a method for constructing a building.

### Industrial Applicability

The present disclosure may provide various advantages to elevators and buildings having such elevators.

What is claimed is:

1. A method for installing an elevator comprising:
providing an opening, at an upper end of a hoist way, aligned with the hoist way in a vertical direction, and disconnecting first elevator components constituting the elevator to be removed;
sequentially withdrawing the first elevator components through the opening, starting from an upper component located in an upper portion of the elevator to be removed and ending with a lower component located in a lower portion of the elevator to be removed;
preparing second elevator components constituting an elevator to be installed;
sequentially introducing the second elevator components through the opening, starting from a lower component located in a lower portion of the elevator to be installed and ending with an upper component located in an upper portion of the elevator to be installed; and
fastening the second elevator components.

2. The method for installing an elevator of claim 1,
wherein the second elevator components include an elevator module of the elevator to be installed, and
wherein the elevator module is provided as a hexahedral frame to which a plurality of bars of predetermined cross-sections extending in the vertical direction, in a front and rear direction, and in a left and right direction are connected.

3. The method for installing an elevator of claim 2, wherein a rail is assembled to the frame.

4. The method for installing an elevator of claim 2, wherein among the elevator modules, a lower end module located at a lower end of the elevator to be installed is provided so as to be detachable from a building.

5. The method for installing an elevator of claim 2,
wherein the elevator module includes at least two elevator modules, and
wherein the elevator modules are fastened to each other.

6. The method for installing an elevator of claim 1,
wherein the opening is provided in one of the following ways:
providing the opening in the wall of the building providing the hoist way when the elevator to be removed is removed, and
providing the opening in the wall of the building when the building having the elevator to be removed is constructed.

7. The method for installing an elevator of claim 1, wherein the opening is closed by a cover after the second elevator components are introduced.

8. The method for installing an elevator of claim 7, wherein at least one of the covers, the first elevator components, and the second elevator components is introduced or withdrawn by a crane.

9. The method for installing an elevator of claim 1, further comprising:
another opening provided by opening the side of the hoist way at the lower portion of the hoist way,
wherein, through the opening, at least one of the first elevator components and the second elevator components is introduced or withdrawn.

10. A method of constructing a building,
wherein, in order to perform the method of claim 1, the opening is provided during construction of the building, and the opening is closed with a cover capable of blocking the opening.

11. A building constructed in accordance with the method of claim 10.

12. An elevator comprising:
a hoist way which is a passage through which a car raises and lowers in a building;
a cover capable of opening or closing an opening provided at an upper end of the hoist way and aligned with the hoist way in a vertical direction;
a platform provided at each floor where the car stops;
a traction machine provided at an upper portion of the hoist way for raising and lowering the car;
a counterweight connected to the opposite side of the car by a rope and moving in the opposite direction of the car;
a door module provided at the platform for opening and closing in conjunction with a door of the car; and
a rail for guiding the movement of at least one of the car and the counterweight in the vertical direction.

13. The elevator of claim 12, wherein the cover is provided on the ceiling of the building.

14. The elevator of claim 12, further comprising:
a step provided on an upper wall of the building for disposing the cover.

15. The elevator of claim 14, wherein the step is a groove recessed downward from the wall toward the hoist way or a protrusion extending upward from the wall.

16. The elevator of claim 14, further comprising:
a hole provided in the cover, a bolt provided in the step and passing through the hole when the cover is seated; and a nut fastened to the bolt.

17. The elevator of claim 12, wherein a lifting protrusion is provided on the cover to lift the cover.

18. The elevator of claim 17, wherein the lifting protrusions are provided at the four corners of the cover of a quadrilateral shape.

19. The elevator of claim 12, further comprising:
an elevator module provided as a hexahedral frame in which at least one of the traction machine, the door module, and the rail is assembled.

20. A method for installing an elevator comprising:
providing an opening at an upper end of a hoist way aligned with the hoist way in a vertical direction, and withdrawing first elevator components through the opening;
preparing second elevator components constituting an elevator to be installed;
introducing second elevator components through the opening; and
closing the opening with a detachable cover from the hoist way after the second elevator components are introduced.
